(19) United States
(12) Patent Application Publication
(10) Pub. No.: US 2024/0274919 A1
(43) Pub. Date: Aug. 15, 2024

(54) BATTERY PACK

(71) Applicant: MURATA MANUFACTURING CO., LTD., Kyoto (JP)

(72) Inventors: Yuta NIKAIDO, Kyoto (JP); Yoshiyuki BANNAI, Kyoto (JP); Shinobu MURAYAMA, Kyoto (JP); Hirohiko TAKADA, Kyoto (JP)

(21) Appl. No.: 18/509,574

(22) Filed: Nov. 15, 2023

(30) Foreign Application Priority Data
Feb. 15, 2023 (JP) 2023-021643

(51) Int. Cl. H01M 10/6555; H01M 10/643; H01M 10/647; H01M 10/653; H01M 50/211; H01M 50/213; H01M 50/291; H01M 50/293

(52) U.S. Cl. CPC H01M 10/6555; H01M 10/643; H01M 10/647; H01M 10/653; H01M 50/211; H01M 50/213; H01M 50/291; H01M 50/293

(57) ABSTRACT

A battery pack according to one aspect of the present technology includes one or a plurality of batteries, one or a plurality of heat absorbing members adjacent to the one or the plurality of batteries, and an exterior case that accommodates the one or the plurality of batteries and the one or the plurality of heat absorbing members. The heat absorbing member includes a thermally irreversible solid material containing water and a packaging case covering the solid material.

### CROSS REFERENCE TO RELATED APPLICATIONS

The present application claims priority to Japanese patent application no. 2023-021643, filed on Feb. 15, 2023, the entire contents of which are incorporated herein by reference.

### BACKGROUND

The present technology relates to a battery pack.

Since electronic equipment has been widely spread, a battery has been developed as a power source applied to the electronic equipment. In this case, in order to handle a plurality of batteries easily and safely, a battery pack including the plurality of batteries has been proposed.

Various studies have been made on the technology related to the configuration of the battery pack. Specifically, a heat absorbing member is in contact with a side surface of the battery unit, and in the heat absorbing member, a heat absorbing agent (gel-like fluid) is enclosed in an exterior film.

### SUMMARY

The present technology relates to a battery pack.

In the battery pack, when one battery in the battery pack generates abnormal heat, another battery adjacent to the battery that has generated abnormal heat is heated, which may generate abnormal heat and cause explosion induction. In the battery pack, it is desired to reduce the possibility of such explosion induction. It is desirable to provide a battery pack capable of reducing the possibility of explosion induction.

A battery pack according to one aspect of the present technology includes one or a plurality of batteries, one or a plurality of heat absorbing members adjacent to the one or the plurality of batteries, and an exterior case that accommodates the one or the plurality of batteries and the one or the plurality of heat absorbing members. The heat absorbing member includes a thermally irreversible solid material containing water and a packaging case covering the solid material.

In the battery pack according to one aspect of the present technology, the one or the plurality of heat absorbing members include a thermally irreversible solid material containing water and a packaging case covering the solid material; therefore, for example, when one battery in the battery pack generates abnormal heat, the packaging case of the heat absorbing member adjacent to the battery that has generated abnormal heat is dissolved, and the solid material covered by the packaging case comes into contact with the battery. At this time, since the solid material includes a thermally irreversible material containing water, when the battery has a high temperature, the material does not flow out to the outside unlike a liquid or a gel, and maintains contact with the battery. As a result, the battery that has generated abnormal heat can be efficiently cooled by the solid material. As a result, the possibility of explosion induction can be reduced.

The effect of the present technology is not necessarily limited to the effect described herein, and may be any suitable effect relating to the present technology.

### BRIEF DESCRIPTION OF THE FIGURES

FIG. 1 is a perspective view showing a perspective configuration example of a battery pack according to an embodiment of the present technology;

FIG. 2 is a view showing a perspective configuration example of a battery module accommodated in the battery pack;

FIG. 3 is a view showing a developed perspective configuration example of the battery pack;

FIG. 4 is a view showing a sectional configuration example of the battery module;

FIG. 5A is a view showing a sectional configuration example of a heat absorbing member. FIG. 5B is a view showing a sectional configuration example of the heat absorbing member taken along line A-A;

FIG. 6 is a view showing a sectional configuration example of a packaging case;

FIG. 7 is a view showing a sectional configuration example of the packaging case;

FIG. 8A is a view showing a perspective configuration example of a heat absorbing agent; FIG. 8B is a view showing a sectional configuration example of the heat absorbing agent taken along line A-A;

FIG. 9A is a view showing an example of a manufacturing process of the heat absorbing member; FIG. 9B is a view showing an example of the manufacturing process subsequent to FIG. 9A;

FIG. 9C is a view showing an example of the manufacturing process subsequent to FIG. 9B;

FIG. 10 is a view showing a modification of the heat absorbing member;

FIG. 11 is a view showing a planar configuration example when the heat absorbing member of FIG. 10 is viewed from a side surface;

FIG. 12 is a view showing a planar configuration example when the heat absorbing member of FIG. 10 is viewed from the side surface;

FIG. 13 is a view showing a sectional configuration example of the heat absorbing member of FIG. 10;

FIG. 14 is a view showing an example of the heat absorbing agent of FIG. 13;

FIG. 15 is a view showing a modification of the heat absorbing member;

FIG. 16 is a view showing a sectional configuration example of the heat absorbing member disposed near a positive electrode of a battery of FIG. 15 and a periphery thereof;

FIG. 17 is a view showing a sectional configuration example of the heat absorbing member disposed near a negative electrode of the battery of FIG. 15 and a periphery thereof;

FIG. 18 is a view showing a sectional configuration example of the heat absorbing member of FIG. 15;

FIG. 19 is a view showing a sectional configuration example of the heat absorbing member of FIG. 15;

FIG. 20 is a view showing a modification of a perspective configuration of the battery module;

FIG. 21 is a view showing a developed perspective configuration example of the battery module of FIG. 20;

FIG. 22A is a view showing a sectional configuration example of the battery and the heat absorbing member of FIG. 20;

FIG. 22B is a view showing a state when the battery of FIG. 22A expands;

FIG. 23 is a view showing a modification of a developed perspective configuration of the battery module;

FIG. 24A is a view showing a sectional configuration example of the battery and the heat absorbing member of FIG. 23; and

FIG. 24B is a view showing a state when the battery of FIG. 24A expands.

### DETAILED DESCRIPTION

The present application is described below in further detail including with reference to the drawings according to one or more embodiments.

First, a battery pack according to an embodiment of the present technology is described.

The battery pack described herein is a power supply including a plurality of batteries, and is applied to a variety of applications such as electronic equipment. The application of the battery pack is detailed later. The type of the battery is not particularly limited, and may be a primary battery or a secondary battery. The type of the secondary battery is not particularly limited, and is specifically a lithium ion secondary battery or the like in which a battery capacity is obtained using occlusion and release of lithium ions. The number of batteries is not particularly limited, and thus can be set arbitrarily. Hereinafter, a case where the battery is a secondary battery (lithium ion secondary battery) will be described. That is, the battery pack described below is a power supply including a plurality of secondary batteries.

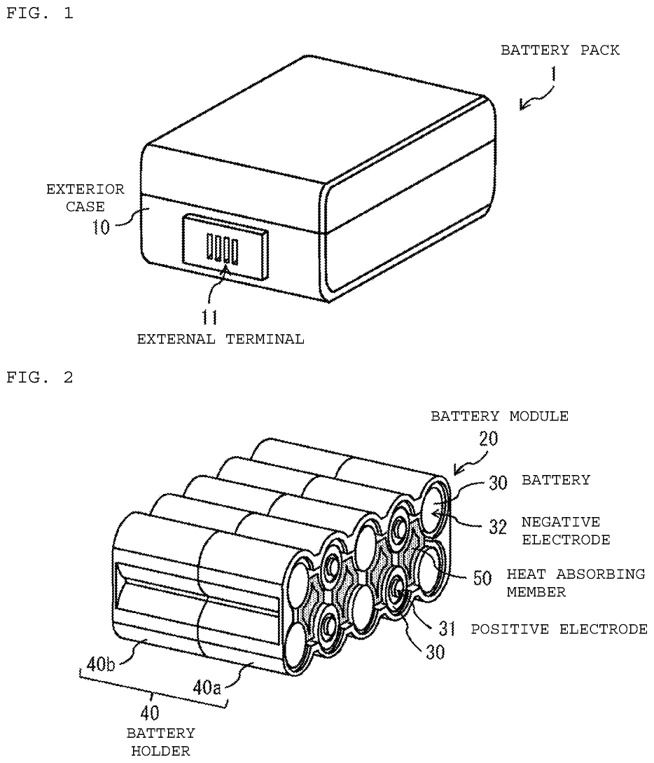

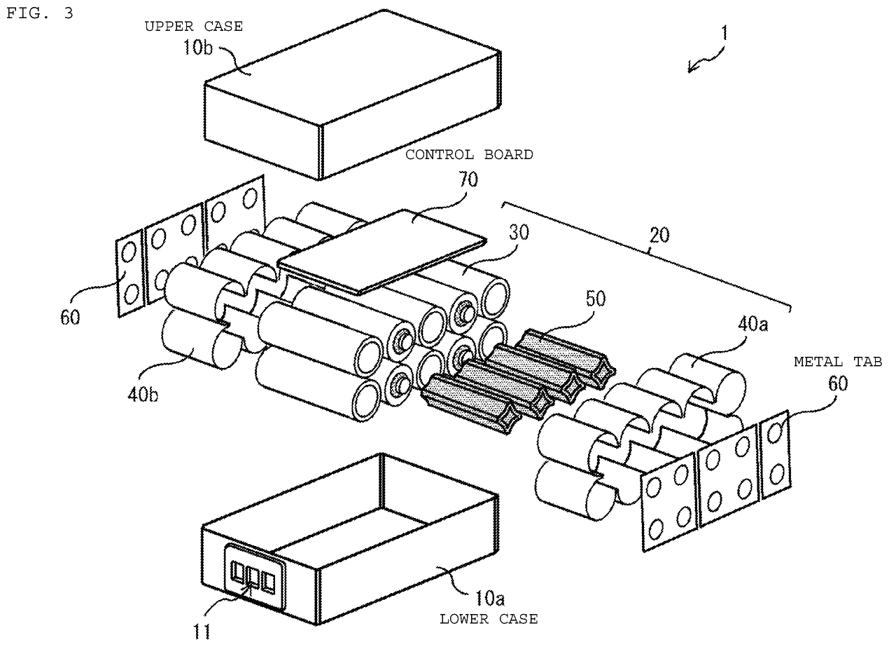

FIG. 1 shows a perspective configuration example of a battery pack 1. FIG. 2 shows a perspective configuration example of a battery module 20 accommodated in the battery pack 1. FIG. 3 shows a developed perspective configuration example of the battery pack 1. FIG. 4 shows a sectional configuration example of the battery module 20.

The battery pack 1 includes, for example, an exterior case 10, the battery module 20, a plurality of metal tabs 60, and a control board 70, as shown in FIGS. 1 to 3. The control board 70 is connected to positive and negative electrode terminals of the battery module 20 with the plurality of metal tabs 60 interposed therebetween, for example, and includes a circuit that measures a voltage of the battery or the battery module 20, detects a remaining capacity of the battery module 20, measures a current output from the battery module 20, and detects the presence or absence of an overcurrent.

The exterior case 10 accommodates the battery module 20, the plurality of metal tabs 60, and the control board 70.

The exterior case 10 includes, for example, a lower case 10a and an upper case 10b as shown in FIG. 3. By overlapping the lower case 10a and the upper case 10b with each other, an accommodation space for accommodating the battery module 20, the plurality of metal tabs 60, and the control board 70 is formed. An external terminal 11 connected to the control board 70 is provided in the exterior case 10 (for example, the lower case 10a). The battery module 20 is connected to the external terminal 11 with the control board 70 interposed therebetween.

The battery pack 1 has a discharge mode in which power output from the battery module 20 is supplied to a load with the external terminal 11 interposed therebetween. The battery pack 1 may further have a charge mode in which power supplied from a power supply, connected to the external terminal 11, with the external terminal 11 interposed therebetween is accumulated in the battery module 20. When a battery 30 described later is a secondary battery, the control board 70 switches between the discharge mode and the charge mode according to the type of a connected object connected to the external terminal 11. When the battery 30 described later is a primary battery, the control board 70 executes only the discharge mode.

The battery module 20 includes a plurality of the batteries 30, for example, as shown in FIGS. 2 and 3. The plurality of batteries 30 are electrically connected with a plurality of metal tabs 60 interposed therebetween. Each of the batteries 30 includes, for example, a positive electrode 31 and a negative electrode 32 as shown in FIG. 2. Each of the batteries 30 is, for example, a cylindrical battery extending in a direction in which the positive electrode 31 and the negative electrode 32 face each other. In the battery module 20, for example, the plurality of batteries 30 which are some of the plurality of batteries 30 are connected in series to each other by the plurality of metal tabs 60, and when the plurality of batteries 30 connected in series to each other are referred to as a series unit, the plurality of series units are connected in parallel to each other by the plurality of metal tabs 60. The connection mode of the plurality of batteries 30 is not limited to the above.

Each of the metal tabs 60 includes, for example, a metal lead plate. Each of the batteries 30 is a primary battery or a secondary battery. When each of the batteries 30 is the secondary battery, the type of the secondary battery is not particularly limited, and is specifically the lithium ion secondary battery or the like in which the battery capacity is obtained using occlusion and release of lithium ions. Hereinafter, a case where each of the batteries 30 is a secondary battery (lithium ion secondary battery) will be described. That is, the battery pack 1 described below is a power supply including a plurality of secondary batteries.

As shown in FIGS. 2 and 3, for example, the battery module 20 further includes a battery holder 40 that supports the plurality of batteries 30, and a plurality of heat absorbing members 50 arranged between the plurality of batteries 30. The battery holder 40 has a structure that supports the plurality of batteries 30 in a hierarchical manner with a predetermined gap interposed therebetween. The heat absorbing member 50 will be described in detail later.

FIG. 4 shows a sectional configuration example of the battery module 20. As shown in FIGS. 3 and 4, for example, the battery holder 40 includes a pair of holder 40a and holder 40b. The holders 40a and 40b both have a common structure.

Each of the holders 40a and 40b has a side plate portion 41, for example, as shown in FIG. 4. The side plate portion 41 of the holder 40a and the side plate portion 41 of the holder 40b are arranged to face each other with the plurality of batteries 30 interposed therebetween in an extending direction of each of the batteries 30 (the direction in which the positive electrode 31 and the negative electrode 32 face each other). In the holders 40a and 40b, the side plate portion 41 has an opening 42 at a position facing the positive electrode 31 and the negative electrode 32 of each of the batteries 30. Therefore, the positive electrode 31 or the negative electrode 32 is exposed in the opening 42.

Each of the holders 40a and 40b further includes a support portion 43 that supports the plurality of batteries 30 in a hierarchical manner with a predetermined gap interposed therebetween, for example, as shown in FIG. 4. One side plate portion 41 is connected to each of both end portions of the support portion 43. Here, it is assumed that the support portion 43 supports four or more cylindrical batteries 30 in a hierarchical manner with a predetermined gap interposed therebetween. At this time, for example, as shown in FIG. 4, the support portion 43 has an opening 44 at a location surrounded by the four cylindrical batteries 30 adjacent to each other. The heat absorbing member 50 is disposed at a position surrounded by the four cylindrical batteries 30 adjacent to each other, and is in contact with outer peripheral surfaces of the four cylindrical batteries 30 via the opening 44. The opening 44 is in contact with the side plate portion 41 of the holder 40a and the side plate portion 41 of the holder 40b, and the heat absorbing member 50 is in contact with the side plate portion 41 of the holder 40a and the side plate portion 41 of the holder 40b via the opening 44.

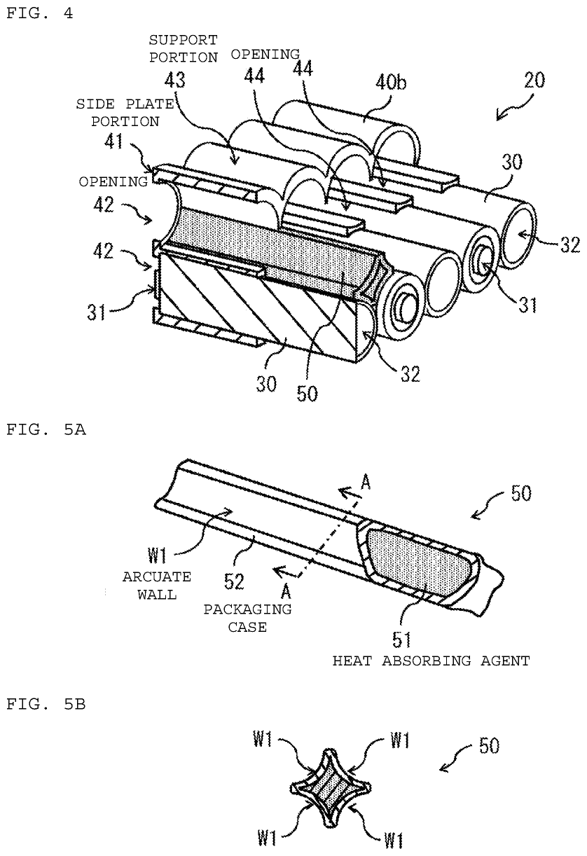

FIG. 5A shows a perspective configuration example of the heat absorbing member 50. FIG. 5B shows a sectional configuration example of the heat absorbing member 50 taken along line A-A. The heat absorbing member 50 has a shape corresponding to a shape of a gap between the plurality of batteries 30 supported by the battery holder 40 (support portion 43). Similarly to the battery 30, the heat absorbing member 50 has an elongated columnar shape. Here, it is assumed that the four or more cylindrical batteries 30 are supported by the battery holder 40 (support portion 43) in a hierarchical manner with a predetermined gap interposed therebetween. At this time, the heat absorbing member 50 is in contact with surfaces (outer peripheral surfaces) of the four cylindrical batteries 30 adjacent to each other, and has a shape corresponding to a shape of a gap between the four cylindrical batteries 30 adjacent to each other, for example. For example, as shown in FIG. 5B, in the heat absorbing member 50, a section in a direction perpendicular to an extending direction of the heat absorbing member 50 has a substantially rhombic shape. The extending direction of the heat absorbing member 50 is a direction parallel to the extending direction of each of the batteries 30 (direction in which the positive electrode 31 and the negative electrode 32 face each other). The sectional shape of the heat absorbing member 50 is not limited to a substantially rhombus shape, and may be, for example, a rhombus shape or another shape.

Here, the four cylindrical batteries 30 adjacent to each other are referred to as a first battery 30, a second battery 30, a third battery 30, and a fourth battery 30. At this time, the heat absorbing member 50 has an arcuate wall W1 (first arcuate wall) extending along the outer peripheral surface of the first battery 30, an arcuate wall W1 (second arcuate wall) extending along the outer peripheral surface of the second battery 30, an arcuate wall W1 (third arcuate wall) extending along the outer peripheral surface of the third battery 30, and an arcuate wall W1 (fourth arcuate wall) extending along the outer peripheral surface of the fourth battery 30. The four arcuate walls W1 have a concave shape following the outer peripheral surface of the battery 30.

For example, as shown in FIGS. 5A and 5B, the heat absorbing member 50 includes a heat absorbing agent 51 and a packaging case 52 covering the heat absorbing agent 51.

The packaging case 52 covers the heat absorbing agent 51. The packaging case 52 is formed by, for example, heating and molding the heat absorbing agent 51 and a resin layer 52a in a state where the heat absorbing agent 51 is covered with the resin layer 52a. Therefore, the packaging case 52 is in contact with the surface of the heat absorbing agent 51.

The packaging case 52 includes a soft sheet material formed of a thermoplastic material. The packaging case 52 includes, for example, the resin layer 52a as shown in FIG. 6 as the soft sheet material. The resin layer 52a contains, for example, a resin material such as polyethylene, polystyrene, polypropylene, or polycarbonate.

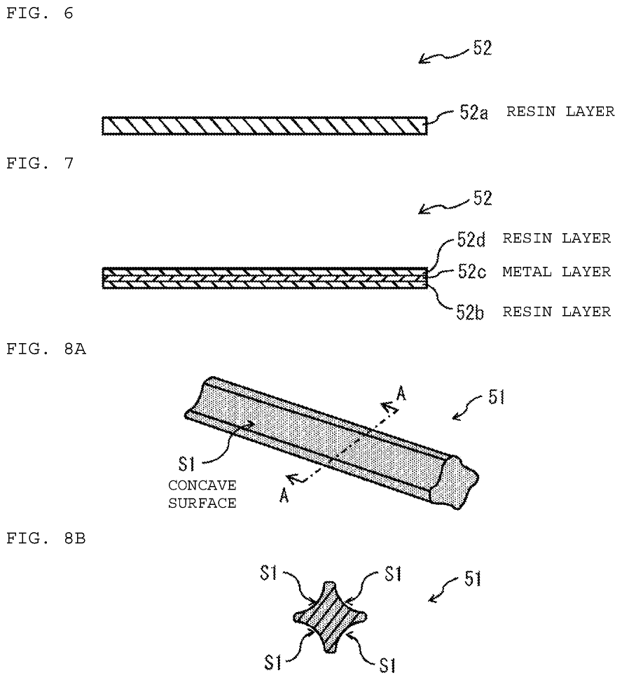

The packaging case 52 may include, for example, a laminated film. The laminated film is, for example, a laminated sheet in which the metal layer 52c is sandwiched between resin layers 52b and 52d as shown in FIG. 7. At this time, the packaging case 52 includes the resin layers 52b and 52d as the soft sheet materials. The resin layers 52b and 52d contain, for example, a resin material such as polyethylene, polystyrene, polypropylene, or polycarbonate. The metal layer 52c include, for example, a metal foil such as an aluminum foil.

The heat absorbing agent 51 includes a thermally irreversible solid material containing water. That is, the heat absorbing agent 51 has such hardness that the heat absorbing agent 51 does not leak out of the battery module 20 due to dissolution, softening, or the like when heated, and can stand alone. The solid material is configured to contain glucomannan. The solid material is formed by, for example, dissolving a glucomannan powder in water to swell the glucomannan, then adding an alkaline solution, heating to gelate, and further solidifying. The acetyl group of glucomannan is deacetylated by reaction with an alkali, and a thermally irreversible solid material is formed by heating the deacetylated glucomannan. A method of producing a solid material is not limited to the above contents.

FIG. 8A shows a perspective configuration example of the heat absorbing agent 51. FIG. 8B shows a sectional configuration example of the heat absorbing agent 51 taken along line A-A. The heat absorbing agent 51 has a shape corresponding to the shape of the gap between the plurality of batteries 30 supported by the battery holder 40 (support portion 43). Similarly to the battery 30, the heat absorbing agent 51 has an elongated columnar shape. Here, it is assumed that the four or more cylindrical batteries 30 are supported by the battery holder 40 (support portion 43) in a hierarchical manner with a predetermined gap interposed therebetween. At this time, the heat absorbing agent 51 has an outer peripheral surface disposed to face the surfaces (outer peripheral surfaces) of the four cylindrical batteries 30 adjacent to each other with the packaging case 52 interposed therebetween, and has, for example, a shape corresponding to the shape of the gap between the four cylindrical batteries 30 adjacent to each other. For example, in the heat absorbing agent 51, a section in a direction perpendicular to an extending direction of the heat absorbing agent 51 has a substantially rhombic shape.

Here, the four cylindrical batteries 30 adjacent to each other are referred to as a first battery 30, a second battery 30, a third battery 30, and a fourth battery 30. At this time, the heat absorbing agent 51 has a concave surface S1 (first concave surface) along the first arcuate wall, a concave surface S1 (second concave surface) along the second arcuate wall, a concave surface S1 (third concave surface) along the third arcuate wall, and a concave surface S1 (fourth concave surface) along the fourth arcuate wall. The four concave surfaces S1 have a concave shape following the outer peripheral surface of the battery 30.

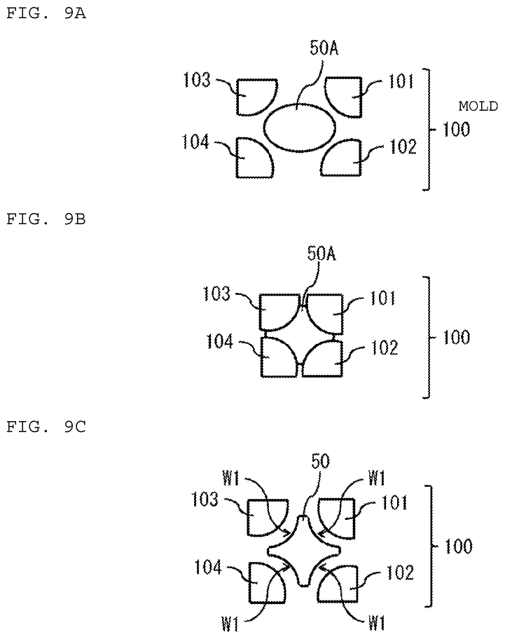

The heat absorbing member 50 can be manufactured through, for example, the steps shown in FIGS. 9A, 9B, and 9C. First, a heat absorbing member 50A in which a gel-like solution is covered with a soft sheet material is provided. The gel-like solution is a solution produced by, for example, dissolving a glucomannan powder in water to swell the glucomannan, and then adding an alkaline solution. Next, for example, as shown in FIG. 9A, the heat absorbing member 50A is disposed in a region surrounded by the four mold pieces 101, 102, 103, and 104. Each of the mold pieces 101, 102, 103, and 104 has a convex surface obtained by inverting the concave surface S1.

Next, for example, as shown in FIG. 9B, the four mold pieces 101, 102, 103, and 104 are pressed against the outer peripheral surface of the heat absorbing member 50A, and in this state, each of the mold pieces 101, 102, 103, and 104 is heated to a predetermined temperature. As a result, the heat of each of the mold pieces 101, 102, 103, and 104 is transmitted to the heat absorbing member 50A, and the gel-like solution is solidified by, for example, deacetylation or the like. At this time, the inverted shape of each of the pressed mold pieces 101, 102, 103, and 104 is imparted to the gel-like solution or the soft sheet material. Thereafter, each of the mold pieces 101, 102, 103, and 104 is detached from the heat absorbing member 50. In this way, the heat absorbing member 50 is formed.

Next, effects of the battery pack 1 will be described.

Since electronic equipment has been widely spread, a battery has been developed as a power source applied to the electronic equipment. In this case, in order to handle a plurality of batteries easily and safely, a battery pack including the plurality of batteries has been proposed.

Various studies have been made on the technology related to the configuration of the battery pack. For example, a heat absorbing member is in contact with a side surface of the battery unit, and in the heat absorbing member, a heat absorbing agent (gel-like fluid) is enclosed in an exterior film (see, for example, International Publication No. 2010/098067).

In the battery pack, when one battery in the battery pack generates abnormal heat, another battery adjacent to the battery that has generated abnormal heat is heated, which may generate abnormal heat and cause explosion induction. In the battery pack, it is desired to reduce the possibility of such explosion induction.

On the other hand, in the present embodiment, each of the heat absorbing members 50 includes the heat absorbing agent 51 which is a thermally irreversible solid material containing water, and the packaging case 52 covering the heat absorbing agent 51. As a result, for example, when one battery 30 in the battery pack 1 generates abnormal heat, the packaging case 52 of the heat absorbing member 50 adjacent to the battery 30 that has generated abnormal heat is dissolved, and the heat absorbing agent 51 covered by the packaging case 52 comes into contact with the battery 30. At this time, since the heat absorbing agent 51 includes a thermally irreversible material containing water, when the battery 30 has a high temperature, the heat absorbing agent does not flow out to the outside unlike a liquid or a gel, and maintains contact with the battery 30. As a result, the battery 30 that has generated abnormal heat can be efficiently cooled by the heat absorbing agent 51. As a result, the possibility of explosion induction can be reduced.

In the present embodiment, the heat absorbing agent 51 contains glucomannan. As a result, the heat absorbing agent 51 can have such hardness that the heat absorbing agent 51 does not leak out of the battery module 20 due to dissolution, softening, or the like when heated, and can stand alone. As a result, when the battery 30 has a high temperature, the heat absorbing agent 51 does not flow out to the outside unlike a liquid or a gel, and maintains contact with the battery 30. As a result, the battery 30 that has generated abnormal heat can be efficiently cooled by the heat absorbing agent 51. Therefore, the possibility of explosion induction can be reduced.

In the present embodiment, the packaging case 52 contains a thermoplastic material. As a result, for example, when one battery 30 in the battery pack 1 generates abnormal heat, the packaging case 52 of the heat absorbing member 50 adjacent to the battery 30 that has generated abnormal heat is dissolved, and the heat absorbing agent 51 covered by the packaging case 52 comes into contact with the battery 30. At this time, since the heat absorbing agent 51 includes a thermally irreversible material containing water, when the battery 30 has a high temperature, the heat absorbing agent does not flow out to the outside unlike a liquid or a gel, and maintains contact with the battery 30. As a result, the battery 30 that has generated abnormal heat can be efficiently cooled by the heat absorbing agent 51. As a result, the possibility of explosion induction can be reduced. Since the packaging case 52 contains the thermoplastic material, the packaging case 52 can be molded together when the heat absorbing agent 51 is molded. As a result, since a degree of freedom of the shape of the heat absorbing member 50 is improved, it is easy to form the heat absorbing member 50 and the heat absorbing agent 51 into a shape having a large contact area between the heat absorbing member 50 and the battery 30. As a result, the battery 30 that has generated abnormal heat can be efficiently cooled by the heat absorbing agent 51. Therefore, the possibility of explosion induction can be reduced.

In the present embodiment, the packaging case 52 includes a soft sheet material formed of a thermoplastic material. As a result, for example, the soft sheet materials welded to each other in the packaging case 52 are dissolved and separated by the heat of the battery 30 that has generated abnormal heat, and the heat absorbing agent 51 covered by the packaging case 52 comes into contact with the battery 30. At this time, since the heat absorbing agent 51 includes a thermally irreversible material containing water, when the battery 30 has a high temperature, the heat absorbing agent does not flow out to the outside unlike a liquid or a gel, and maintains contact with the battery 30. As a result, the battery 30 that has generated abnormal heat can be efficiently cooled by the heat absorbing agent 51. As a result, the possibility of explosion induction can be reduced. Since the packaging case 52 includes the soft sheet material formed of the thermoplastic material, the packaging case 52 can be molded together when the heat absorbing agent 51 is molded. As a result, since a degree of freedom of the shape of the heat absorbing member 50 is improved, it is easy to form the heat absorbing member 50 and the heat absorbing agent 51 into a shape having a large contact area between the heat absorbing member 50 and the battery 30. As a result, the battery 30 that has generated abnormal heat can be efficiently cooled by the heat absorbing agent 51. Therefore, the possibility of explosion induction can be reduced.

In the present embodiment, the packaging case 52 includes a laminated sheet in which the metal layer 52c is sandwiched between the resin layers 52b and 52d. As a result, for example, the resin layers 52b and 52d welded to each other in the packaging case 52 are dissolved and separated by the heat of the battery 30 that has generated abnormal heat, and the heat absorbing agent 51 covered by the packaging case 52 comes into contact with the battery 30. At this time, since the heat absorbing agent 51 includes a thermally irreversible material containing water, when the battery 30 has a high temperature, the heat absorbing agent does not flow out to the outside unlike a liquid or a gel, and maintains contact with the battery 30. As a result, the battery 30 that has generated abnormal heat can be efficiently cooled by the heat absorbing agent 51. As a result, the possibility of explosion induction can be reduced. Since the packaging case 52 contains the laminated sheet, the packaging case 52 can be molded together when the heat absorbing agent 51 is molded. As a result, since a degree of freedom of the shape of the heat absorbing member 50 is improved, it is easy to form the heat absorbing member 50 and the heat absorbing agent 51 into a shape having a large contact area between the heat absorbing member 50 and the battery 30. As a result, the battery 30 that has generated abnormal heat can be efficiently cooled by the heat absorbing agent 51. Therefore, the possibility of explosion induction can be reduced.

In the present embodiment, each of the batteries 30 is a cylindrical battery, and the plurality of heat absorbing members 50 are arranged at positions surrounded by the four adjacent batteries 30. As a result, for example, when one battery 30 in the battery pack 1 generates abnormal heat, heat generated from the battery 30 that has generated abnormal heat is absorbed by the heat absorbing member 50, and a ratio of propagation to the battery 30 adjacent to the battery 30 that has generated abnormal heat can be significantly reduced. As a result, the possibility of explosion induction can be reduced.

In the present embodiment, the heat absorbing member 50 has the four arcuate walls W1. Accordingly, the contact area between the heat absorbing member 50 and the four batteries 30 arranged around the heat absorbing member 50 can be increased. As a result, heat generated from the battery 30 that has generated abnormal heat can be efficiently absorbed by the heat absorbing member 50. Therefore, the possibility of explosion induction can be reduced.

In the present embodiment, the heat absorbing agent 51 has the four concave surfaces S1. Accordingly, a distance between the heat absorbing agent 51 and the four batteries 30 arranged around the heat absorbing member 50 can be reduced. As a result, heat generated from the battery 30 that has generated abnormal heat can be efficiently absorbed by the heat absorbing member 50. Therefore, the possibility of explosion induction can be reduced.

In the present embodiment, when the number of the batteries 30 is four, the number of the heat absorbing members 50 may be one. At this time, the heat absorbing member 50 is disposed at the position surrounded by the four adjacent batteries 30. Even in such a case, the possibility of explosion induction can be reduced.

Next, a modification of the battery pack 1 according to the above embodiment will be described.

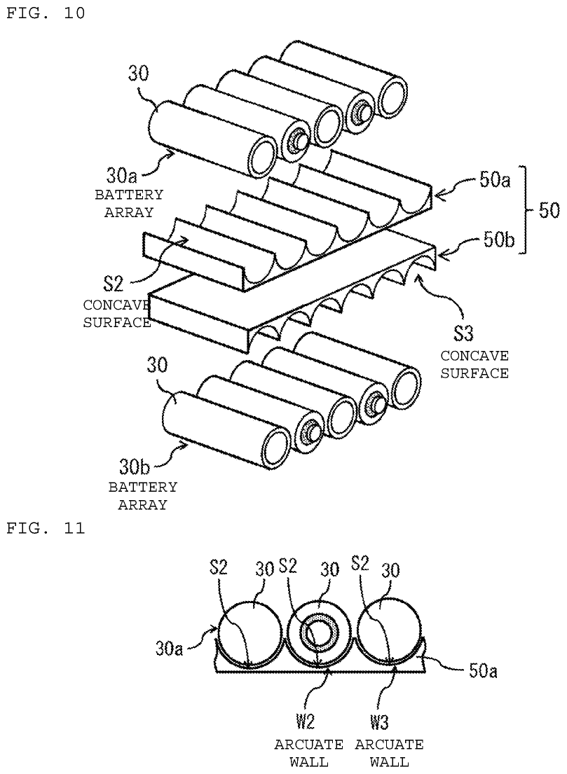

In the above embodiment, the heat absorbing member 50 may include, for example, two heat absorbing members 50a and 50b as shown in FIG. 10. The heat absorbing members 50a and 50b both have a common structure.

For example, as shown in FIG. 10, the heat absorbing member 50a is disposed along a battery array 30a in which the plurality of batteries 30 are arranged side by side in a direction orthogonal to the extending direction of the battery 30. For example, as shown in FIG. 10, the heat absorbing member 50b is disposed along another battery array 30b in which the plurality of batteries 30 are arranged side by side in the direction orthogonal to the extending direction of the battery 30. In each battery array, the two batteries 30 are arranged adjacent to each other.

A part of the heat absorbing member 50a is disposed between the two batteries 30 adjacent to each other in the battery array 30a. In the heat absorbing member 50a, a portion disposed between the two batteries 30 adjacent to each other has, for example, as shown in FIG. 11, a part of an arcuate wall W2 (first arcuate wall) extending along the outer peripheral surface of one of the two adjacent batteries 30 and a part of an arcuate wall W3 (second arcuate wall) extending along the outer peripheral surface of other one of the two adjacent batteries 30. In the heat absorbing member 50a, for example, as shown in FIGS. 10 and 11, a plurality of concave surfaces S2 each including one of the arcuate wall W2 and the arcuate wall W3 are formed at a position facing the battery array 30a. The outer peripheral surface of one battery 30 included in the battery array 30a is in contact with the concave surface S2.

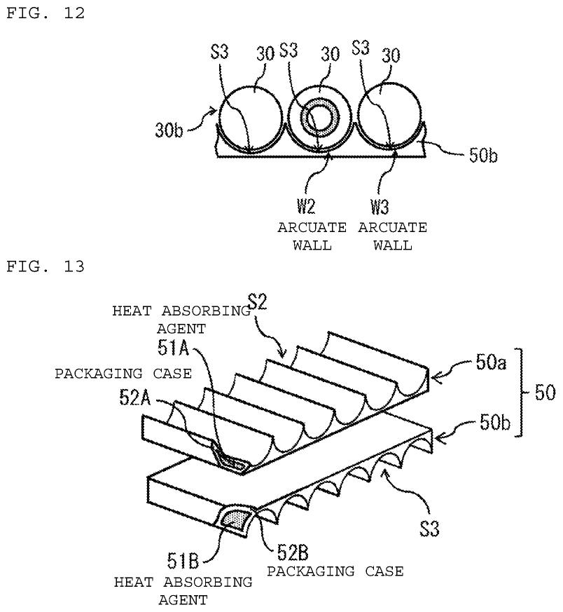

A part of the heat absorbing member 50b is disposed between the two batteries 30 adjacent to each other in the battery array 30b. In the heat absorbing member 50b, a portion disposed between the two adjacent batteries 30 has, for example, as shown in FIG. 12, a part of the arcuate wall W2 (first arcuate wall) extending along the outer peripheral surface of one of the two adjacent batteries 30 and a part of the arcuate wall W3 (second arcuate wall) extending along the outer peripheral surface of other one of the two adjacent batteries 30. In the heat absorbing member 50b, for example, as shown in FIGS. 10 and 12, a plurality of concave surfaces S3 each including one of the arcuate wall W2 and the arcuate wall W3 are formed at a position facing the battery array 30b. The outer peripheral surface of the battery 30 included in the battery array 30b is in contact with the concave surface S3.

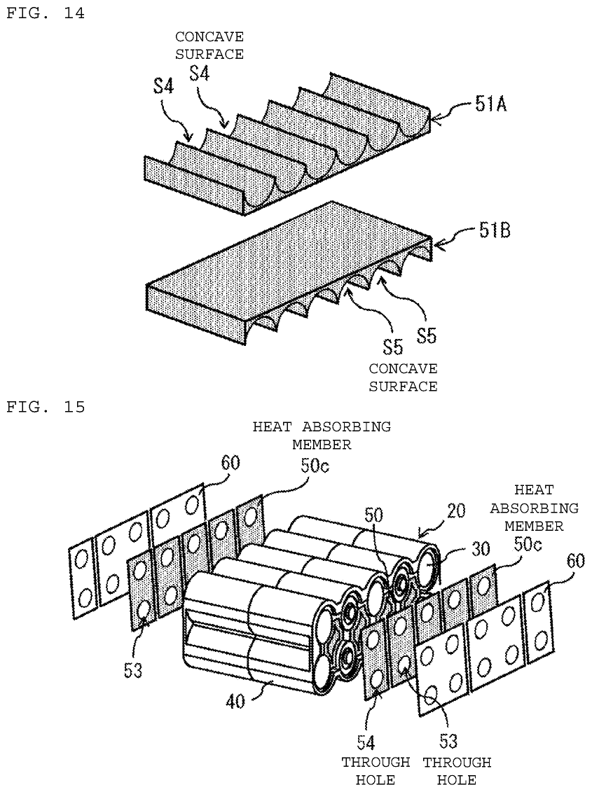

FIG. 13 is a view showing a sectional configuration example of the heat absorbing members 50a and 50b. FIG. 14 is a view showing a perspective configuration example of heat absorbing agents 51A and 51B included in the heat absorbing members 50a and 50b.

For example, as shown in FIG. 13, the heat absorbing member 50a includes the heat absorbing agent 51A and a packaging case 52A covering the heat absorbing agent 51A.

The packaging case 52A covers the heat absorbing agent 51A. The packaging case 52A is formed by, for example, heating and molding the heat absorbing agent 51A and the resin layer 52a (see, FIG. 6) in a state where the heat absorbing agent 51A is covered with the resin layer 52a (see, FIG. 6). Therefore, the packaging case 52A is in contact with the surface of the heat absorbing agent 51A. The packaging case 52A includes a soft sheet material formed of a thermoplastic material. The packaging case 52A includes, for example, the resin layer 52a (see, FIG. 6) as the soft sheet material. The packaging case 52A may include, for example, a laminated film. The laminated film is, for example, a laminated sheet in which the metal layer 52c is sandwiched between the resin layers 52b and 52d (see FIG. 7). At this time, the packaging case 52A includes the resin layers 52b and 52d as the soft sheet materials.

For example, as shown in FIGS. 11 and 14, the heat absorbing agent 51A has a concave surface S4 (first concave surface) along the arcuate wall W2 (first arcuate wall) and a concave surface S4 (second concave surface) along the arcuate wall W3 (first arcuate wall). A plurality of the concave surfaces S4 are formed in a common surface of the heat absorbing agent 51A. The plurality of concave surfaces S4 are arranged side by side in a direction orthogonal to an extending direction of the concave surface S4 in the heat absorbing agent 51A. The extending direction of the concave surface S4 is a direction parallel to the extending direction of each of the batteries 30 (direction in which the positive electrode 31 and the negative electrode 32 face each other). The concave surface S4 has a concave shape following the outer peripheral surface of the battery 30. The heat absorbing agent 51A contains a material common to the heat absorbing agent 51 described above, and is produced by a method common to the heat absorbing agent 51 described above.

For example, as shown in FIG. 13, the heat absorbing member 50b includes the heat absorbing agent 51B and a packaging case 52B covering the heat absorbing agent 51B.

The packaging case 52B covers the heat absorbing agent 51B. The packaging case 52B is formed by, for example, heating and molding the heat absorbing agent 51B and the resin layer 52a (see, FIG. 6) in a state where the heat absorbing agent 51B is covered with the resin layer 52a (see, FIG. 6). Therefore, the packaging case 52B is in contact with the surface of the heat absorbing agent 51B. The packaging case 52B includes a soft sheet material formed of a thermoplastic material. The packaging case 52B includes, for example, the resin layer 52a (see, FIG. 6) as the soft sheet material. The packaging case 52B may include, for example, a laminated film. The laminated film is, for example, a laminated sheet in which the metal layer 52c is sandwiched between the resin layers 52b and 52d (see FIG. 7). At this time, the packaging case 52B includes the resin layers 52b and 52d as the soft sheet materials.

For example, as shown in FIGS. 11 and 14, the heat absorbing agent 51B has a concave surface S5 (first concave surface) along the arcuate wall W2 (first arcuate wall) and a concave surface S5 (second concave surface) along the arcuate wall W3 (first arcuate wall). A plurality of the concave surfaces S5 are formed in a common surface of the heat absorbing agent 51A. The plurality of concave surfaces S5 are arranged side by side in a direction orthogonal to an extending direction of the concave surface S5 in the heat absorbing agent 51A. The extending direction of the concave surface S5 is a direction parallel to the extending direction of each of the batteries 30 (direction in which the positive electrode 31 and the negative electrode 32 face each other). The concave surface S5 has a concave shape following the outer peripheral surface of the battery 30. The heat absorbing agent 51B contains a material common to the heat absorbing agent 51 described above, and is produced by a method common to the heat absorbing agent 51 described above.

In this modification, each of the batteries 30 is a cylindrical battery, a part of the heat absorbing member 50a is disposed between the two batteries 30 adjacent to each other in the battery array 30a, and a part of the heat absorbing member 50b is disposed between the two batteries 30 adjacent to each other in the battery array 30b. As a result, for example, when one battery 30 in the battery pack 1 generates abnormal heat, heat generated from the battery 30 that has generated abnormal heat is absorbed by the heat absorbing members 50a and 50b, and the ratio of propagation to the battery 30 adjacent to the battery 30 that has generated abnormal heat can be significantly reduced. As a result, the possibility of explosion induction can be reduced.

In the present modification, each of the heat absorbing members 50a and 50b has the two arcuate walls W2 and W3. Accordingly, the contact area between the heat absorbing members 50a and 50b and the two batteries 30 arranged around the heat absorbing members 50a and 50b can be increased. As a result, heat generated from the battery 30 that has generated abnormal heat can be efficiently absorbed by the heat absorbing members 50a and 50b. Therefore, the possibility of explosion induction can be reduced.

In the present modification, the heat absorbing agent 51A has the two concave surfaces S4, and the heat absorbing agent 51B has the two concave surfaces S5. Accordingly, a distance between the heat absorbing agents 51A and 51B and the two batteries 30 arranged around the heat absorbing members 50a and 50b can be reduced. As a result, heat generated from the battery 30 that has generated abnormal heat can be efficiently absorbed by the heat absorbing members 50a and 50b. Therefore, the possibility of explosion induction can be reduced.

In the above embodiment and the modifications, for example, as shown in FIG. 15, the battery module 20 may further include a plurality of heat absorbing members 50c provided between the plurality of batteries 30 and the plurality of metal tabs 60 (or the exterior case 10).

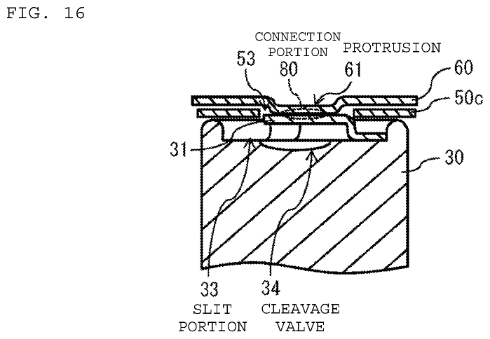

FIG. 16 shows a sectional configuration example of the heat absorbing member 50c disposed near the positive electrode of the battery 30 and a periphery thereof. FIG. 17 shows a sectional configuration example of the heat absorbing member 50c disposed near the negative electrode of the battery 30 and a periphery thereof. For example, as shown in FIG. 15, the plurality of heat absorbing members 50c are provided between an end portion on the positive electrode 31 side and an end portion on the negative electrode 32 side of the battery 30 and the plurality of metal tabs 60.

The positive electrode 31 has a protruding shape on an end surface on which the positive electrode 31 is provided. On the end surface on which the positive electrode 31 is provided, one or a plurality of slit portions 33 are provided around the positive electrode 31. On the end surface on which the positive electrode 31 is provided, a gap is provided on a back surface side of the positive electrode 31, and this gap communicates with one or a plurality of the slit portions 33. A cleavage valve 34 is provided at a bottom of the gap. The cleavage valve 34 has a function of discharging a gas generated in the battery 30 to the outside when the battery 30 generates abnormal heat. The negative electrode 32 forms a flat surface at an end surface on which the negative electrode 32 is provided.

It is assumed that the plurality of batteries 30 are arranged side by side in a two-dimensional direction orthogonal to the extending direction of the battery 30 (direction in which the positive electrode 31 and the negative electrode 32 face each other). At this time, in the plurality of batteries 30 provided in the battery pack 1, the end surface of one battery 30 (first battery) of the two batteries 30 adjacent to each other and the end surface of the other battery 30 (second battery) of the two batteries 30 adjacent to each other are arranged in the same plane. The plurality of metal tabs 60 are arranged so as to face each other with the plurality of batteries 30, provided in the battery pack 1, sandwiched in the extending direction of the batteries 30.

The metal tab 60 is electrically connected to a positive electrode 31 of the first battery and a negative electrode 32 of the second battery. The electrical connection between the metal tab 60 and the positive electrode 31 is achieved by, for example, a connection portion 80 as shown in FIG. 16. The electrical connection between the metal tab 60 and the negative electrode 32 is achieved by, for example, a connection portion 90 as shown in FIG. 17. The battery pack 1 includes the connection portions 80 and 90.

The connection portion 80 is a portion where a protrusion 61 of the metal tab 60 and the positive electrode 31 are connected. The protrusion 61 is provided at a position facing the positive electrode 31 in the metal tab 60. The protrusion 61 has a shape protruding in the positive electrode 31 direction. In the present embodiment, the protrusion 61 and the positive electrode 31 are connected by welding. For example, laser welding or resistance welding is used for welding. The connection portion 80 is not limited to the above, and the protrusion 61 and the positive electrode 31 may be connected by a method other than welding. For example, connection by screwing, connection by crimping, or the like may be used.

The connection portion 90 is a portion where a protrusion 62 of the metal tab 60 and the negative electrode 32 are connected. The protrusion 62 is provided at a position facing the negative electrode 32 in the metal tab 60. The protrusion 62 has a shape protruding in the negative electrode 32 direction. In the present embodiment, the protrusion 62 and the negative electrode 32 are connected by welding. For example, laser welding or resistance welding is used for welding. The connection portion 90 is not limited to the above, and the protrusion 62 and the negative electrode 32 may be connected by a method other than welding. For example, connection by screwing, connection by crimping, or the like may be used.

The heat absorbing member 50c is provided between the positive electrode 31 of the first battery (battery 30) and the metal tab 60, and at least in a part of a peripheral region of the connection portion 80. The heat absorbing member 50c is in contact with an end surface of the first battery on which the positive electrode 31 is provided. The heat absorbing member 50c may further be in contact with the metal tab 60. The heat absorbing member 50c has a through hole 53 through which the connection portion 80 is inserted. At this time, the heat absorbing material 60 is disposed so as to surround the periphery of the connection portion 80.

The heat absorbing member 50c is provided between the negative electrode 32 of the second battery (battery 30) and the metal tab 60, and at least in a part of a peripheral region of the connection portion 90. The heat absorbing member 50c is in contact with an end surface of the second battery on which the negative electrode 32 is provided. The heat absorbing member 50c may further be in contact with the metal tab 60. The heat absorbing member 50c has a through hole 54 through which the connection portion 90 is inserted. At this time, the heat absorbing material 60 is disposed so as to surround the periphery of the connection portion 90.

The through hole 53 may be configured such that an inner surface of the through hole 53 is in contact with a side surface of the connection portion 80, or may be configured such that the inner surface of the through hole 53 is slightly away from the side surface of the connection portion 80. The connection portion 80 may be inserted into the through hole 53, or the connection portion 80 may be fitted into the through hole 53. When the connection portion 80 is inserted into the through hole 53, the connection portion 80 may have, for example, a circular shape in plan view, and the through hole 53 may have, for example, a circular shape having a diameter equal to or larger than a diameter of the connection portion 80 in plan view.

The through hole 53 may be configured such that the inner surface of the through hole 53 is in contact with a side surface of the connection portion 90, or may be configured such that the inner surface of the through hole 53 is slightly away from the side surface of the connection portion 90. The connection portion 90 may be inserted into the through hole 53, or the connection portion 90 may be fitted into the through hole 53. When the connection portion 90 is inserted into the through hole 53, the connection portion 90 may have, for example, a circular shape in plan view, and the through hole 53 may have, for example, a circular shape having a diameter equal to or larger than a diameter of the connection portion 90 in plan view.

In either case, the heat absorbing member 50c is provided so as to cover one or the plurality of slit portions 33.

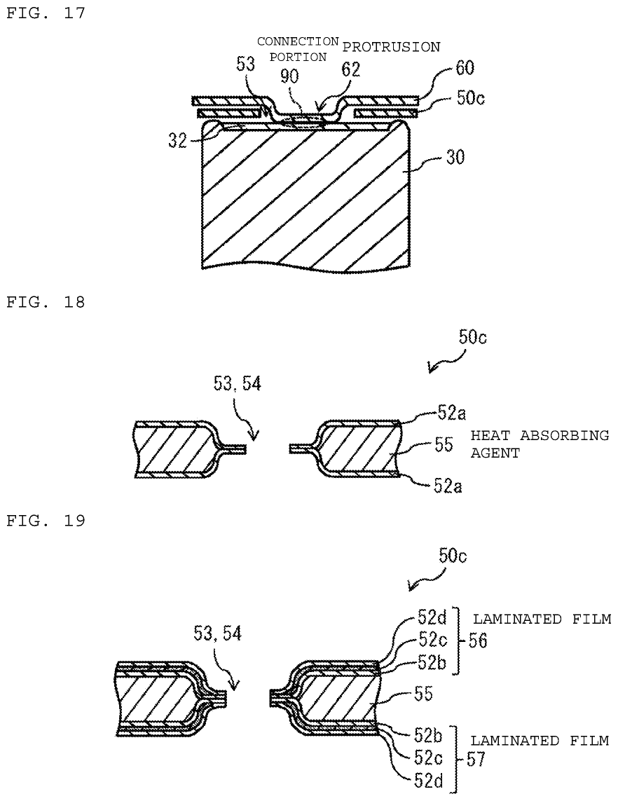

FIG. 18 shows a sectional configuration example of the through holes 53 and 54 and the periphery thereof in the heat absorbing member 50c. For example, as shown in FIG. 18, the heat absorbing member 50c includes a heat absorbing agent 55 and a resin layer 52a (packaging case) covering the heat absorbing agent 55. The resin layer 52a is formed by, for example, heating and molding the heat absorbing agent 55 and the resin layer 52a in a state where the heat absorbing agent 55 is covered with the resin layer 52a. Therefore, the resin layer 52a is in contact with the surface of the heat absorbing agent 55. The resin layer 52a includes a soft sheet material formed of a thermoplastic material. The resin layer 52a contains, for example, a resin material such as polyethylene, polystyrene, polypropylene, or polycarbonate.

For example, as shown in FIG. 19, the heat absorbing member 50c may include a heat absorbing agent 55 and laminated films 56 and 57 (packaging cases) covering the heat absorbing agent 55. The laminated films 56 and 57 are each, for example, a laminated sheet in which the metal layer 52c is sandwiched between the resin layers 52b and 52d as shown in FIG. 19. At this time, the laminated films 56 and 57 each include, for example, the resin layers 52b and 52d as the soft sheet materials. The resin layers 52b and 52d contain, for example, a resin material such as polyethylene, polystyrene, polypropylene, or polycarbonate. The metal layer 52c include, for example, a metal foil such as an aluminum foil.

The heat absorbing agent 55 includes a thermally irreversible solid material containing water. That is, the heat absorbing agent 55 has such hardness that the heat absorbing agent 55 does not leak out of the battery module 20 due to dissolution, softening, or the like when heated, and can stand alone. The solid material is configured to contain glucomannan. The solid material is formed by, for example, dissolving a glucomannan powder in water to swell the glucomannan, then adding an alkaline solution, heating to gelate, and further solidifying. The acetyl group of glucomannan is deacetylated by reaction with an alkali, and a thermally irreversible solid material is formed by heating the deacetylated glucomannan. A method of producing a solid material is not limited to the above contents.

In the present modification, the heat absorbing member 50c is provided between the battery 30 and the metal tab 60 (or the exterior case 10) and around the connection portions 80 and 90. As a result, when gas ejected from the battery 30 that has generated abnormal heat comes into contact with the heat absorbing member 50c, the resin layer 52a or the laminated films 56 and 57 of the heat absorbing member 50c is/are broken, and the heat absorbing agent 55 is exposed. At this time, since the heat absorbing agent 55 includes a thermally irreversible material containing water, when the ejected gas has a high temperature, the heat absorbing agent does not flow out to the outside unlike a liquid or a gel, and maintains contact with the battery 30. As a result, the ejected gas and the battery 30 that has generated abnormal heat can be efficiently cooled by the heat absorbing agent 55. As a result, the possibility of explosion induction can be reduced.

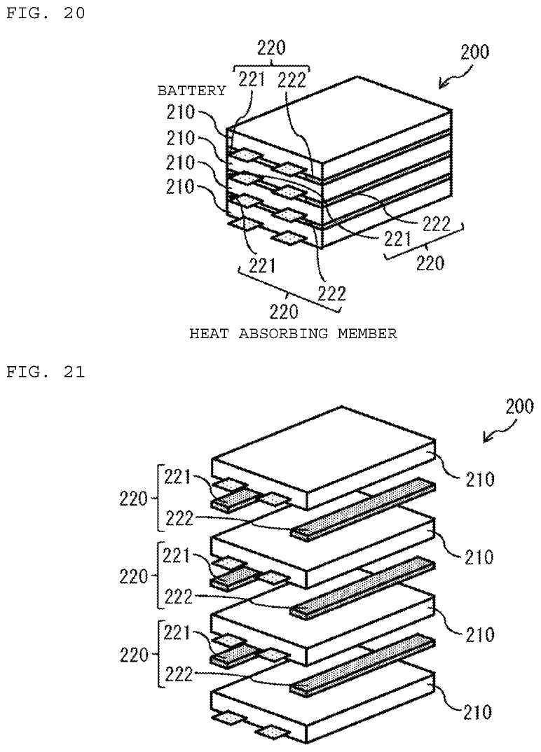

In the above embodiment and the modifications, for example, a battery module 200 as shown in FIGS. 20 and 21 may be provided instead of the battery module 20. FIG. 20 shows a perspective configuration example of the battery module 200. FIG. 21 shows a developed perspective configuration example of the battery module 200. For example, as shown in FIGS. 20 and 21, the battery module 200 includes a plurality of batteries 210 and a plurality of heat absorbing members 220.

The plurality of batteries 210 are stacked in a thickness direction of the batteries 210. The thickness direction of the battery 210 refers to a direction in which an upper surface of the battery 210 and a bottom surface of the battery 210 face each other. The upper surface of the battery 210 refers to the upper surface of the battery 210 when the battery module 200 is accommodated in the exterior case 10. The bottom surface of the battery 210 refers to the bottom surface of the battery 210 when the battery module 200 is accommodated in the exterior case 10. The plurality of heat absorbing members 220 are stacked in the same direction as the stacking direction of the plurality of batteries 210. The plurality of batteries 210 and the plurality of heat absorbing members 220 are alternately arranged in the stacking direction of the plurality of batteries 210. One heat absorbing member 220 is provided between the two batteries 210 adjacent to each other. The heat absorbing member 220 is in contact with each of the two batteries 210 arranged above and below the heat absorbing member 220.

The plurality of batteries 210 are electrically connected with a plurality of metal tabs interposed therebetween. The battery 210 is a rectangular laminate film type battery. The battery 210 includes, for example, a positive electrode and a negative electrode on a side surface. In the battery module 200, for example, the plurality of batteries 210 which are some of the plurality of batteries 210 are connected in series to each other by the plurality of metal tabs, and when the plurality of batteries 210 connected in series to each other are referred to as a series unit, the plurality of series units are connected in parallel to each other by the plurality of metal tabs. The connection mode of the plurality of batteries 210 is not limited to the above.

Each of the batteries 210 is a primary battery or a secondary battery. When each of the batteries 210 is the secondary battery, the type of the secondary battery is not particularly limited, and is specifically the lithium ion secondary battery or the like in which the battery capacity is obtained using occlusion and release of lithium ions. Hereinafter, a case where each of the batteries 210 is a secondary battery (lithium ion secondary battery) will be described. That is, the battery pack 1 described below is a power supply including a plurality of secondary batteries.

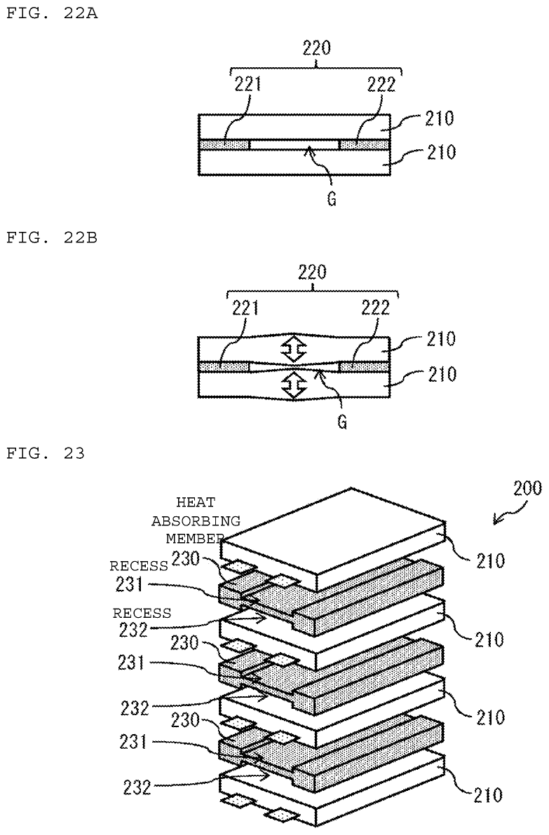

For example, as shown in FIGS. 20 and 21, the heat absorbing member 220 includes two heat absorbing members 221 and 222 arranged to face each other with a predetermined gap interposed therebetween in a two-dimensional plane orthogonal to the stacking direction of the battery 210. Each of the heat absorbing members 221 and 222 extends in a direction orthogonal to an opposing direction of the heat absorbing members 221 and 222. For example, a gap G as shown in FIG. 22A is formed between the heat absorbing member 221 and the heat absorbing member 222. The gap G is formed between the two batteries 210 adjacent to each other and at least at a position facing a central portion of the battery 210. The heat absorbing member 220 is not limited to the heat absorbing members 221 and 222, and has a configuration capable of forming the gap G at least at the position facing the central portion of the battery 210.

For example, as shown in FIG. 22B, the gap G is a clearance for preventing the battery module 200 from being compressed by the exterior case 10 or breaking the exterior case 10 due to expansion of the two batteries 210 in contact with the heat absorbing members 221 and 222 due to aging, for example. Therefore, the heat absorbing member 220 has not only a function of cooling the battery 210 that has generated abnormal heat but also a function as a spacer for securing the gap G.

Each of the heat absorbing members 221 and 222 has the same configuration as the heat absorbing member 50. Each of the heat absorbing members 221 and 222 includes, for example, a heat absorbing agent made of the same material as the heat absorbing agent 51, and a packaging case covering the heat absorbing agent and made of the same material as the packaging case 52. In the heat absorbing members 221 and 222, the packaging case covers the heat absorbing agent.

The packaging case is formed by, for example, heating and molding the heat absorbing agent and the resin layer 52a (see, FIG. 6) in a state where the heat absorbing agent is covered with the resin layer 52a. The packaging case may be formed by, for example, heating and molding the heat absorbing agent and the laminated film (see, FIG. 7) in a state where the heat absorbing agent is covered with the laminated film. In either case, the packaging case is in contact with the surface of the heat absorbing agent.

In the present modification, the plurality of batteries 210 and the plurality of heat absorbing members 220 are alternately arranged in the stacking direction of the battery 210. As a result, for example, when one battery 210 in the battery pack 1 generates abnormal heat, the packaging case of the heat absorbing member 220 adjacent to the battery 210 that has generated abnormal heat is dissolved, and the heat absorbing agent covered by the packaging case comes into contact with the battery 210. At this time, since the heat absorbing agent includes a thermally irreversible material containing water, when the battery 210 has a high temperature, the heat absorbing agent does not flow out to the outside unlike a liquid or a gel, and maintains contact with the battery 210. As a result, the battery 210 that has generated abnormal heat can be efficiently cooled by the heat absorbing agent. As a result, the possibility of explosion induction can be reduced.

In the present modification, the gap G formed by the heat absorbing member 220 is formed between the two batteries 210 adjacent to each other and at least at the position facing the central portion of the battery 210. As a result, it is possible to prevent the battery module 200 from being compressed by the exterior case 10 or the exterior case 10 from being broken due to expansion of the two batteries 210 in contact with the heat absorbing member 220 due to aging, for example.

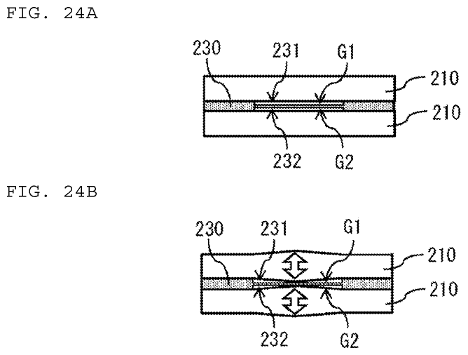

In an embodiment, a heat absorbing member 230 as shown in FIG. 23 may be provided instead of the heat absorbing member 220. FIG. 23 shows a developed perspective configuration example of the battery module 200. For example, as shown in FIG. 23, the battery module 200 includes a plurality of batteries 210 and a plurality of heat absorbing members 230.

The plurality of batteries 210 are stacked in a thickness direction of the batteries 210. The plurality of heat absorbing members 230 are stacked in the same direction as the stacking direction of the plurality of batteries 210. The plurality of batteries 210 and the plurality of heat absorbing members 230 are alternately arranged in the stacking direction of the plurality of batteries 210. One heat absorbing member 230 is provided between the two batteries 210 adjacent to each other. The heat absorbing member 230 is in contact with each of the two batteries 210 arranged above and below the heat absorbing member 230.

In the heat absorbing member 230, a sectional shape parallel to the stacking direction of the battery 210 is, for example, an H shape as shown in FIG. 23. A recess 231 extending in a first direction orthogonal to the stacking direction of the battery 210 is formed on an upper surface of the heat absorbing member 230, and a recess 232 extending in the first direction is formed on a lower surface of the heat absorbing member 230. For example, a gap G1 as shown in FIG. 24A is formed between the recess 231 and the battery 210. For example, a gap G2 as shown in FIG. 24A is formed between the recess 232 and the battery 210. Each of the recesses 231 and 232 is formed at least at the position facing the central portion of the battery 210. Therefore, each of the gaps G1 and G2 is formed at least at the position facing the central portion of the battery 210.

For example, as shown in FIG. 24B, the gaps G1 and G2 are clearances for preventing the battery module 200 from being compressed by the exterior case 10 or the exterior case 10 from being broken due to expansion of the two batteries 210 in contact with the heat absorbing member 230 due to aging, for example. Therefore, the heat absorbing member 230 has not only the function of cooling the battery 210 that has generated abnormal heat but also the function as a spacer for securing the gap G.

Each of the heat absorbing members 230 has the same configuration as the heat absorbing member 50. Each of the heat absorbing members 230 includes, for example, a heat absorbing agent made of the same material as the heat absorbing agent 51, and a packaging case covering the heat absorbing agent and made of the same material as the packaging case 52. In the heat absorbing member 230, the packaging case covers the heat absorbing agent.

The packaging case is formed by, for example, heating and molding the heat absorbing agent and the resin layer 52a (see, FIG. 6) in a state where the heat absorbing agent is covered with the resin layer 52a. The packaging case may be formed by, for example, heating and molding the heat absorbing agent and the laminated film (see, FIG. 7) in a state where the heat absorbing agent is covered with the laminated film. In either case, the packaging case is in contact with the surface of the heat absorbing agent.

In the present modification, the plurality of batteries 210 and the plurality of heat absorbing members 230 are alternately arranged in the stacking direction of the battery 210. As a result, for example, when one battery 210 in the battery pack 1 generates abnormal heat, the packaging case of the heat absorbing member 230 adjacent to the battery 210 that has generated abnormal heat is dissolved, and the heat absorbing agent covered by the packaging case comes into contact with the battery 210. At this time, since the heat absorbing agent includes a thermally irreversible material containing water, when the battery 210 has a high temperature, the heat absorbing agent does not flow out to the outside unlike a liquid or a gel, and maintains contact with the battery 210. As a result, the battery 210 that has generated abnormal heat can be efficiently cooled by the heat absorbing agent. As a result, the possibility of explosion induction can be reduced.

In the present modification, the gaps G1 and G2 formed by the heat absorbing member 230 are formed between the two batteries 210 adjacent to each other and at least at the position facing the central portion of the battery 210. As a result, it is possible to prevent the battery module 200 from being compressed by the exterior case 10 or the exterior case 10 from being broken due to expansion of the two batteries 210 in contact with the heat absorbing member 230 due to aging, for example.

The present technology has been described above with reference to the above embodiment and the modifications; however, the present technology is not limited to the aspects described in the above embodiment and the modifications, and various modifications may be made to the present technology.

For example, in the above embodiment and the modifications, although lithium is used as an electrode reactant of the secondary battery, the type of the electrode reactant is not particularly limited. Specifically, the electrode reactant may be another element of Group 1 in the long-periodic table (such as sodium or potassium), an element of Group 2 in the long-periodic table (such as magnesium or calcium) or another light metal (such as aluminum).

In addition, the effects described in the present specification are not limiting but are merely examples, and there may be additional effects.

The present technology may also take the following configurations.

<1>

A battery pack including:
one or a plurality of batteries;
one or a plurality of heat absorbing members adjacent to the one or the plurality of batteries; and
an exterior case that accommodates the one or the plurality of batteries and the one or the plurality of heat absorbing members,
wherein the heat absorbing member includes a thermally irreversible solid material containing water and a packaging case covering the solid material.
   <2>

The battery pack according to <1>, wherein the solid material includes glucomannan.

<3>

The battery pack according to <1> or <2>, wherein the packaging case contains a thermoplastic material.

<4>

The battery pack according to <3>, wherein the packaging case includes a soft sheet material formed of a thermoplastic material.

<5>

The battery pack according to <3>, wherein the packaging case includes a laminated sheet in which a metal foil is sandwiched between soft sheet materials formed of a thermoplastic material.

<6>

The battery pack according to any one of <1> to <5>, wherein
the battery pack includes a plurality of the batteries,
each of the batteries is a cylindrical battery,
the plurality of the batteries are arranged in such a way that the two batteries are adjacent to each other, and
the one or the plurality of heat absorbing members are arranged between the two batteries adjacent to each other.
   <7>

The battery pack according to <6>, wherein the one or the plurality of heat absorbing members include
a first arcuate wall extending along an outer peripheral surface of one of the two batteries adjacent to each other, and
a second arcuate wall extending along an outer peripheral surface of the other of the two batteries adjacent to each other.
   <8>

The battery pack according to <7>, wherein in the one or the plurality of heat absorbing members, the solid material has a first concave surface along the first arcuate wall and a second concave surface along the second arcuate wall.

<9>

The battery pack according to any one of <1> to <5>, further including a plurality of the batteries,
wherein each of the batteries is a cylindrical battery,
the plurality of the batteries are arranged in such a way that the four batteries are adjacent to each other, and
the one or the plurality of heat absorbing members are arranged at positions surrounded by the four batteries adjacent to each other.
   <10>

The battery pack according to <9>, wherein the one or the plurality of heat absorbing members include
a first arcuate wall extending along an outer peripheral surface of a first battery among the four batteries adjacent to each other,
a second arcuate wall extending along an outer peripheral surface of a second battery among the four batteries adjacent to each other,
a third arcuate wall extending along an outer peripheral surface of a third battery among the four batteries adjacent to each other, and
a fourth arcuate wall extending along an outer peripheral surface of a fourth battery among the four batteries adjacent to each other.
   <11>

The battery pack according to <10>, wherein in the one or the plurality of heat absorbing members, the solid material has a first concave surface along the first arcuate wall, a second concave surface along the second arcuate wall, a third concave surface along the third arcuate wall, and a fourth concave surface along the fourth arcuate wall.

<12>

The battery pack according to any one of <1> to <11>, wherein the one or the plurality of heat absorbing members are arranged between the one or the plurality of batteries and the exterior case.

<13>

The battery pack according to any one of <1> to <5>, further including a plurality of the batteries,
wherein each of the batteries is a rectangular laminate film type battery,
the plurality of the batteries are stacked in a thickness direction of the battery,
the one or the plurality of heat absorbing members are stacked in the same direction as the stacking direction of the battery,
the plurality of the batteries and the one or the plurality of heat absorbing members are alternately arranged in the stacking direction of the battery, and
the one or the plurality of heat absorbing members are configured to form a gap between the two batteries adjacent to each other and at least at a position facing a central portion of the battery.

What is claimed is:

1. A battery pack comprising:
one or a plurality of batteries;
one or a plurality of heat absorbing members adjacent to the one or the plurality of batteries; and
an exterior case that accommodates the one or the plurality of batteries and the one or the plurality of heat absorbing members,
wherein the heat absorbing member includes a thermally irreversible solid material containing water and a packaging case covering the solid material.

2. The battery pack according to claim 1, wherein the solid material includes glucomannan.

3. The battery pack according to claim 1, wherein the packaging case contains a thermoplastic material.

4. The battery pack according to claim 3, wherein the packaging case includes a soft sheet material formed of a thermoplastic material.

5. The battery pack according to claim 3, wherein the packaging case includes a laminated sheet in which a metal foil is sandwiched between soft sheet materials formed of a thermoplastic material.

6. The battery pack according to claim 1, wherein
the battery pack includes a plurality of the batteries,
each of the batteries is a cylindrical battery,
the plurality of the batteries are arranged in such a way that the two batteries are adjacent to each other, and
the one or the plurality of heat absorbing members are arranged between the two batteries adjacent to each other.

7. The battery pack according to claim 6, wherein the one or the plurality of heat absorbing members include
a first arcuate wall extending along an outer peripheral surface of one of the two batteries adjacent to each other, and
a second arcuate wall extending along an outer peripheral surface of the other of the two batteries adjacent to each other.

8. The battery pack according to claim 7, wherein in the one or the plurality of heat absorbing members, the solid material has a first concave surface along the first arcuate wall and a second concave surface along the second arcuate wall.

9. The battery pack according to claim 1, further comprising a plurality of the batteries,
wherein each of the batteries is a cylindrical battery,
the plurality of the batteries are arranged in such a way that the four batteries are adjacent to each other, and
the one or the plurality of heat absorbing members are arranged at positions surrounded by the four batteries adjacent to each other.

10. The battery pack according to claim 9, wherein the one or the plurality of heat absorbing members include
a first arcuate wall extending along an outer peripheral surface of a first battery among the four batteries adjacent to each other,
a second arcuate wall extending along an outer peripheral surface of a second battery among the four batteries adjacent to each other,
a third arcuate wall extending along an outer peripheral surface of a third battery among the four batteries adjacent to each other, and
a fourth arcuate wall extending along an outer peripheral surface of a fourth battery among the four batteries adjacent to each other.

11. The battery pack according to claim 10, wherein in the one or the plurality of heat absorbing members, the solid material has a first concave surface along the first arcuate wall, a second concave surface along the second arcuate wall, a third concave surface along the third arcuate wall, and a fourth concave surface along the fourth arcuate wall.

12. The battery pack according to claim 1, wherein the one or the plurality of heat absorbing members are arranged between the one or the plurality of batteries and the exterior case.

13. The battery pack according to claim 1, further comprising a plurality of the batteries,
wherein each of the batteries is a rectangular laminate film type battery,
the plurality of the batteries are stacked in a thickness direction of the battery,
the one or the plurality of heat absorbing members are stacked in the same direction as the stacking direction of the battery,
the plurality of the batteries and the one or the plurality of heat absorbing members are alternately arranged in the stacking direction of the battery, and
the one or the plurality of heat absorbing members are configured to form a gap between the two batteries adjacent to each other and at least at a position facing a central portion of the battery.
